(19) United States
(12) Patent Application Publication
(10) Pub. No.: US 2005/0201648 A1
(43) Pub. Date: Sep. 15, 2005

(54) Combined sensor and bearing assembly

(75) Inventor: Seiichi Takada, Kuwana-shi (JP)

Correspondence Address: STAAS & HALSEY LLP, SUITE 700, 1201 NEW YORK AVENUE, N.W., WASHINGTON, DC, 20005, US

(73) Assignee: NTN CORPORATION, Osaka (JP)

(21) Appl. No.: 11/072,440

(22) Filed: Mar. 7, 2005

(30) Foreign Application Priority Data
Mar. 10, 2004 (JP) 2004-066510

(51) Int. Cl. F16C 32/00; F16C 41/04

(52) U.S. Cl. 384/448

(57) ABSTRACT

A combined sensor and bearing assembly of the present invention includes a bearing (1) having an inner race (2) and an outer race (3), and a rotation sensor unit (11) having a code wheel (6) and a sensor (10). The sensor (10) is mounted on the non-rotating outer race (3) and the code wheel (6) is provided on a rotary member (30) rotatable together with the rotating inner race (2). The code wheel (6) is mounted on the rotary member (30) with an annular end face of the inner race (2) taken as a reference in positioning. The rotation sensor unit (11) is, for example, an optical rotation sensor unit. A sensor housing (20) concurrently serves as a non-contact sealing member for sealing an annular bearing space between the inner and outer races (2) and (3).

### BACKGROUND OF THE INVENTION

1. Field of the Invention

The present invention relates to a combined sensor and bearing assembly incorporating an optical or magnetic rotation sensor.

2. Description of the Prior Art

The bearing assembly equipped with an optical rotation sensor is known, in which a sensor unit including a light emitting element for projecting a detecting beam and a light receiving sensor for sensing the detecting beam is incorporated in one of the inner and outer races of the bearing assembly, which is a non-rotating race, and, on the other hand, a code wheel for generating a train of pulses is mounted on the other of the inner and outer races, which is a rotating race. The code wheel is in the form of a disc having a plurality of light reflecting areas and a corresponding number of light non-reflecting areas defined on at least one of opposite surfaces thereof. See, for example, the Japanese Laid-open Patent Publication No. 9-297151.

It is well recognized that the optical rotation sensor can have a high resolution if the numbers of the light reflecting and non-reflecting areas of the code wheel are increased and can also have a higher resolution if the number of the sensors used therewith is increased. However, since the code wheel of the conventional bearing assembly is incorporated in the rotating race such as the bearing inner race, a displacement would possibly occur between the rotating race with the code wheel incorporated therein and a rotary member such as a shaft with the rotating race mounted thereon in the event that when the bearing assembly is loaded, the rotating race undergoes a creeping motion (slippage).

Particularly where the combined sensor and bearing assembly is used in a business machine such as a copying machine or a printer, it is often possible that when the bearing assembly is loosely mounted on a rotary member in the business machine, the possibility of the creeping is high. In the case of the bearing mounted on a shaft, difference in peripheral length between the shaft and the bearing inner race is apt to result in the displacement and the amount of displacement of the shaft cannot be accurately counted, with the sensor consequently failing to achieve a highly accurate sensing.

### SUMMARY OF THE INVENTION

Accordingly, the present invention is intended to provide an improved combined sensor and bearing assembly capable of highly accurately measuring the revolution without the accuracy of a rotation sensor unit being adversely affected even though slippage occurs between a rotating race of the bearing and a rotary member such as a shaft having the rotating race fixed thereto.

In order to accomplish the foregoing object of the present invention, there is, in accordance with the present invention, provided a combined sensor and bearing assembly which includes a bearing having a rotating race and a non-rotating race, and a rotation sensor unit having a code wheel and a sensor. The sensor is mounted on the non-rotating race and the code wheel is provided on a rotary member rotatable together with the rotating race.

According to the present invention, since the code wheel is provided on the rotary member the revolution of which is desired to be detected, a highly accurate measurement is possible without the accuracy of detecting the number of revolutions of the rotary member by the rotation sensor unit being adversely affected, even though a creep (slippage) occurs between the rotating race and the rotary member. In view of this, incorporation of the bearing in a machine requiring a bearing can easily be accomplished.

The code wheel is a member separate from the rotary member and is mounted fixedly on the rotary member. According to this feature, no special machining of the rotary member is required for the mounting of the code wheel on the rotary member and any existing rotary member can be employed in the practice of the present invention. Therefore, this feature has a high utility.

Preferably, the bearing is a radial type rolling bearing, in which case the rotating race is an inner race and the rotary member is a rotary shaft engaged in the inner race.

A creep (slippage) is generally easy to occur between the inner race of the rolling bearing and the rotary member. This is particularly true where the inner race of the rolling bearing is loosely mounted on the rotary member. Accordingly, since according to the present invention the code wheel is mounted on the rotary member, the accuracy of detection of the sensor unit does not lower and a highly accurate measurement is possible even when the creep occurs between the inner race and the rotary member.

Where the bearing is a radial type rolling bearing, the code wheel may be mounted on the rotary member with an annular end face of the rotating race taken as a reference in positioning with respect to an axial direction of the bearing.

When using the end face of the rotating race as the axial reference the code wheel is mounted on the rotary member, the relative position between the sensor and the code wheel can be secured, thereby facilitating the assemblage.

Alternatively, the code wheel may be formed on a portion of the rotary member. Formation of the code wheel on the portion of the rotary member is advantageous in that even though a creep occurs between the rotating race and the rotary member, such creep does not adversely affect the detecting accuracy of the sensor unit and, therefore, a highly accurate measurement of the revolution of the rotary member can be accomplished.

Where the code wheel is provided directly on the rotary member, the bearing is preferably a radial type rolling bearing; the rotating race is an inner race; and the rotary member is a rotary shaft having a large diameter shaft portion and a small diameter shaft portion with an annular step defined between the large and small diameter shaft portions. In this case, the code wheel is provided on the large diameter shaft portion and the annular step is preferably held in abutment with the annular end face of the rotating race.

When the annular step in the rotary member is held in abutment with the end face of the rotating race, the position of the code wheel with respect to the axial direction of the bearing can be fixed with the end face of the rotating race taken as a reference. For this reason, assemblage of the rotary member relative to the rotating race can easily be achieved.

Where the code wheel is formed directly on the rotary member, a code signal inducing element of the code wheel is preferably printed on the rotary member. This is particularly advantageous in that the code signal inducing element can easily be formed.

In the practice of the present invention, the rotation sensor unit may be either an optical rotation sensor unit or a magnetic rotation sensor unit. However, the various advantages and effects brought about by the present invention can be appreciated particularly where the rotation sensor unit is an optical rotation sensor unit.

The optical rotation sensor unit has a relatively high resolution as compared with that of the magnetic rotation sensor unit. However, mounting of the code wheel on the rotating race such as practiced in the prior art brings about a considerable reduction in detecting accuracy and, therefore, it may occur that the high detecting accuracy peculiar to the optical rotation sensor unit will not be exhibited effectively. Contrary to the prior art, since in the present invention the code wheel is mounted on the rotary member, the present invention is advantageous in that an effect of increasing the measuring accuracy can be brought about by avoiding the influences due to the creep.

In another preferred embodiment, the optical rotation sensor unit includes a sensor mounted on the non-rotating race through a ring-shaped sensor housing engageable with the non-rotating race. The housing concurrently serves as a sealing element for sealing an annular bearing space between the rotating and non-rotating races. Allowing the sensor housing to have a sealing capability is effective to avoid an undesirable reduction in amount of a lubricant for the bearing due to leakage and, also, to avoid the scattering of the lubricant over the sensor, which causes a detection failure. Also, no extra dedicated sealing member is needed to seal the bearing on the side of the sensor unit and, therefore, the rotation sensor unit can be assembled compact with a minimized number component parts by means of a minimized number of assembling steps.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a fragmentary longitudinal sectional view of a combined sensor and bearing assembly according to a first preferred embodiment of the present invention;

FIG. 2 is a perspective view showing the relation between a rotation sensor unit and a rotary member;

FIG. 3 is a fragmentary longitudinal sectional view of the combined sensor and bearing assembly according to a second preferred embodiment of the present invention; and

FIG. 4 is a fragmentary longitudinal sectional view of the combined sensor and bearing assembly according to a third preferred embodiment of the present invention.

### DETAILED DESCRIPTION OF THE EMBODIMENTS

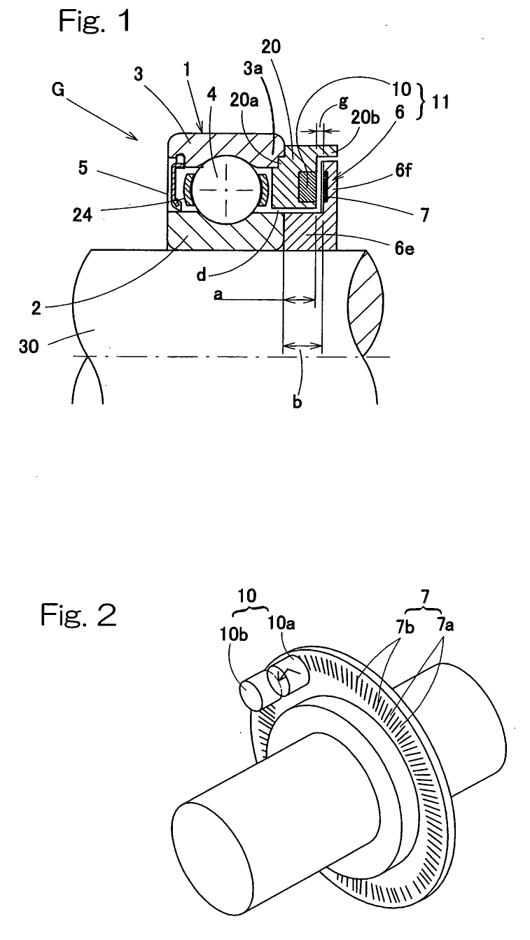

A first preferred embodiment of the present invention will now be described in detail with particular reference to FIGS. 1 and 2. A combined sensor and bearing assembly according to the first embodiment includes a bearing 1 and a rotation sensor unit 11 incorporated into the bearing 1. The bearing 1 is a radial rolling bearing and includes an inner race 2, which is a rotating race; an outer race 3, which is a non-rotating race; and a row of rolling elements 4 rollingly interposed between the inner race 2 and the outer race 3. The bearing 1 is specifically a deep groove ball bearing and, hence, the rolling elements 4 are balls operatively retained by a ball retainer 24. An annular bearing space delimited between the inner and outer races 2 and 3 has opposite open ends, one of which is sealed by a sealing member 5. A rotation sensor unit 11 is arranged in the vicinity of the other of the opposite open ends of the annular bearing space.

The rotation sensor unit 11 includes a code wheel 6 and a sensor 10. In the illustrated embodiment, the rotation sensor unit 11 is in the form of an optical rotation sensor unit of an axial type, in which the code wheel 6 and the sensor 10 are arranged so as to confront with each other in an axial direction of the bearing 1.

The sensor 10 is mounted on the stationary outer race 3 through a ring-shaped sensor housing 20, whereas the code wheel 6 is mounted on a rotary member 30 rotatable together with the rotating inner race 2. The rotary member 30 is a rotary shaft and the inner race 2 is fixedly mounted on the rotary member 30. For this purpose, the inner race 2 may be mounted on the rotary member 30 under interference fit. Alternatively, the inner race 2 may be loosely mounted on the rotary member 30, in which case the inner race 2 may be axially fixed on the rotary member 30 by the use of stop rings (not shown). The outer race 3 is fitted to a housing of a machine or equipment incorporating the combined sensor and bearing assembly.

The code wheel 6 is a member separate from the rotary member 30 and is fixedly mounted on an outer peripheral surface of the rotary member 30. An end face of the inner race 2 is used as a reference in positioning the code wheel 6 on the rotary member 30. This code wheel 6 may be fixed on the rotary member 30 either under interference fit or by the use of a bonding agent.

The sensor 10 is fixedly mounted on the ring-shaped sensor housing 20. The housing 20 has one end face formed with a mounting protrusion 20a that is press-fittedly engaged with a step-like end face 3a of the outer race 3 to fix the housing 20 to the outer race 3. The end face 3a of the outer race 3 is used as an axial reference in positioning the housing 20 relative to the outer race 3. This sensor housing 20 concurrently serves as a non-contact sealing element for closing the other of the opposite ends of the annular bearing space between the inner and outer races 2 and 3.

The details of the code wheel 6 will now be described. This code wheel 6 includes a cylindrical portion 6e, fixed on the rotary member 30, and a radial flange 6f protruding radially outwardly from one end of the cylindrical portion 6e, with a code signal inducing element 7 defined in an annular inner surface of the radial flange 6f so as to deploy in a circumferential direction of the flange 6f as shown in FIG. 2. The code signal inducing element 7 is made up of a plurality of light reflecting areas 7a and a corresponding number of light non-reflecting areas 7b alternating with the light reflecting areas 7a in a predetermined pattern, for example, a grid pattern. The cylindrical portion 6e has an outer diameter substantially equal to an outer diameter of the inner race 2 and is held in end-to-end abutment with the inner race 2.

The sensor 10 is made up of a light emitting element 10a for projecting a detecting beam towards the code wheel 6 and a light receiving element 10b for receiving a reflected light, that is, the detecting beam that has been reflected from the code wheel 6. The light emitting element 10a may be a light emitting diode whereas the light receiving element 10 may be a phototransistor. The light emitting element 10a and the light receiving element 10b are embedded in the sensor housing 20 so as to confront the code signal inducing element 7, with a light emitting face of the light emitting element 10a and a light receiving face of the light receiving element 10b exposed bare.

In the illustrated embodiment, a single set of the light emitting and receiving elements 10a and 10b is shown and employed for the sensor 10. However, where the direction of revolution of the rotary member 30 is desired to be detected, two sets of the light emitting and receiving elements 10a and 10b may be employed, in which case the two sets of the light emitting and receiving elements 10a and 10b have to be spaced from each other in a direction circumferentially of the code wheel 6 so that detection signals outputted from the light receiving elements 10b, respectively, can have about 90° phase difference.

The sensor housing 20 has, in addition to the mounting protrusion 20a formed with the one end face thereof, an axial cylindrical collar 20b extending from an outer peripheral edge portion of the opposite end face thereof. An inner peripheral surface of the sensor housing 20 is positioned in close proximity to an outer peripheral surface of the inner race 2 with a labyrinth seal gap d formed therebetween. The gap d is communicated to the outside of the combined sensor and bearing assembly through a space between the sensor housing 20 and the code wheel 6 and then through a space between the radial flange 6f of the code wheel 6 and the cylindrical collar 20b of the sensor housing 20. Each of the sensor housing 20 and the code wheel 6 is made of a metallic material, but a synthetic resin may be employed as a material therefor.

According to the first embodiment, since the light receiving element 10b detects the detecting beam which has been projected from the light emitting element 10a of the sensor 10 and subsequently reflected by the reflecting areas 7a of the code wheel 6, a revolution pulse signal can be obtained and, hence, the number of revolutions and the direction of revolution of the rotary member 30 can be detected.

When the bearing 1 is loaded during its operation, it may occur that the inner race 2 undergoes a creeping motion relative to the rotary member 30, resulting in a deviation in phase of revolution. However, even though this deviation in phase of revolution occurs, the accuracy of detecting the number of revolutions of the rotary member 30 is not adversely affected since the code wheel 6 is mounted on the rotary member 30 the revolution of which is desired to be detected. For this reason, the detecting accuracy of the optical rotation sensor unit 11 does not lower and, accordingly, a highly accurate measurement is possible. Also, in view of this, the bearing 1 can easily be incorporated into, for example, a business machine.

Since the end face of the inner race 2 is used as an axial reference in positioning for the mounting of the code wheel 6 to the rotary member 30, mere abutment of the code wheel 6 against the end face of the inner race 2 can result in setting of a proper value for the gap g between the code wheel 6 and the sensor 10, thereby facilitating the assemblage. In other words, if manufacture is made by controlling the distance b from an end face of the code wheel 6 adjacent the inner race 2 to a surface of the code signal inducing element 7 and the distance a from the end face of the sensor housing 20, which is held in abutment with the outer race 3, to a surface of the sensor 10, mere positioning of the code wheel 6 so as to be held in abutment with the end face of the inner race 2 and of the sensor housing 20 so as to be held in abutment with the end face of the outer race 3 can result in the gap g of a proper value. For this reason, incorporation of the rotation sensor unit 11 in the bearing 1 and incorporation of the bearing 1 in the machine that requires a bearing can easily be accomplished.

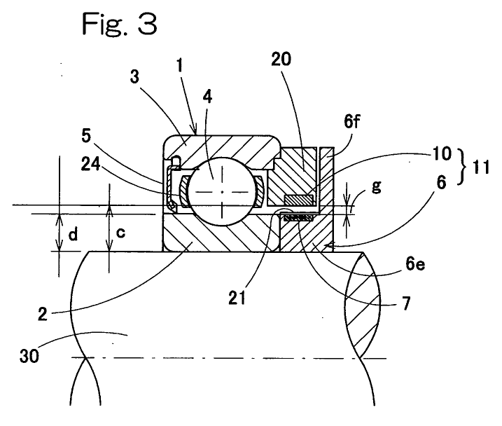

In the foregoing embodiment, the rotation sensor unit 11 has been shown and described as the axial type, in which the code wheel 6 and the sensor 10 are arranged so as to confront with each other in the axial direction of the bearing 1. However, in the following second preferred embodiment which will now be described with particular reference to FIG. 3, the rotation sensor unit 11 is of a radial type, in which the code wheel 6 and the sensor 10 are arranged so as to confront with each other in a radial direction of the bearing 1.

As shown in FIG. 3, the cylindrical portion 6e of the code wheel 6 has an outer peripheral surface provided with a code signal inducing element 7 oriented in the radial direction of the bearing 1. This code signal inducing element 7 is similar to that employed in the foregoing embodiment, shown in and described with reference to FIGS. 1 and 2, in that the light reflecting and non-reflecting areas are formed so as to alternate with each other in a direction circumferentially thereof in a predetermined pattern, for example, a grid pattern. The sensor 10 is embedded in the inner peripheral surface of the sensor housing 20 so as to radially inwardly confront the code signal inducing element 7 in the code wheel 6. It is to be noted that in this second embodiment the cylindrical collar 20b shown in FIG. 1 is dispensed with.

Other structural features of the combined sensor and bearing assembly shown in FIG. 3 than those described above are substantially similar to those shown in and described in connection with the first embodiment with reference to FIGS. 1 and 2 and, therefore, the details thereof are not reiterated for the sake of brevity.

Even according to the second embodiment shown in FIG. 3, since the code wheel 6 is mounted on the rotary member 30, the accuracy of detection of the rotation sensor unit 11 is not adversely affected even though a creep is developed between the inner race 2 and the rotary member 30, allowing a highly accurate measurement of the revolution of the rotary member 30 to be possible. Also, the sensor housing 20 provides a sealing effect. The gap g between the code wheel 6 and the rotation sensor 10 can have a proper value during assemblage if the difference d in diameter between the inner and outer peripheral surfaces of the code wheel 6 and the difference c in diameter between the detecting surface of the sensor 10 in the sensor housing 20 and the outer peripheral surface of the rotary member 30 are properly controlled.

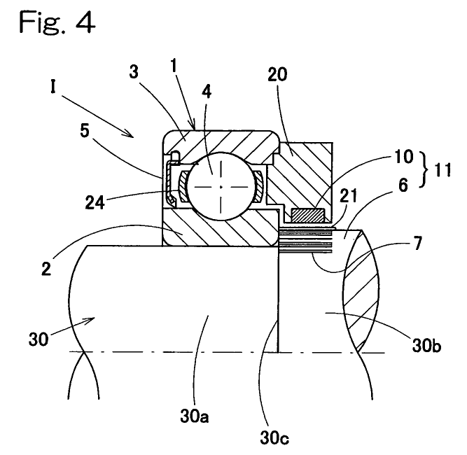

FIG. 4 illustrates a third preferred embodiment of the present invention. This embodiment is substantially similar to the second embodiment, shown in FIG. 3, except that the code wheel 6 forming a part of the rotation sensor unit 11 is formed directly on the rotary member 30 that is rotatable together with the inner race 2 serving as the rotating race. More specifically, the code signal inducing element 7 of the code wheel 6 is formed on a portion of the outer peripheral surface of the rotary member 30 by means of a printing technique to form the code wheel as a part of the rotary member 30. The light reflecting and non-reflecting areas 7a and 7b of the code signal inducing element 7 alternate with each other in a predetermined pattern, for example, a grid pattern in a direction circumferentially of the rotary member 30.

The rotary member 30 is preferably a shaft made up of a small diameter shaft portion 30a, fixedly engaged in the inner race 2, and a large diameter shaft portion 30b with an annular step 30c defined between it and the small diameter shaft portion 30a. The code wheel 6, that is, the code signal inducing element 7 is formed on an outer peripheral surface of the large diameter portion 30b of the rotary member 30. The end face of the inner race 2 can be used as an axial reference in positioning the rotary member 30 relative to the inner race 2 in a manner that the step 30c is brought into abutment with the end face of the inner race 2.

The sensor 10 is embedded in the inner peripheral surface of the ring-shaped sensor housing 20. This sensor housing 20 employed in this third embodiment concurrently serves as a non-contact sealing element for sealing one of the open ends of the annular bearing space between the inner and outer races 2 and 3 remote from the sealing member 5.

Other structural features of the combined sensor and bearing assembly shown in FIG. 4 than those described above are substantially similar to those shown in and described in connection with the second embodiment with reference to FIG. 3 and, therefore, the details thereof are not reiterated for the sake of brevity.

According to the third embodiment, since the code wheel 6 is mounted on the rotary member 30, the accuracy of detection of the rotation sensor unit 11 is not adversely affected even though a creep is developed between the inner race 2 and the rotary member 30, allowing a highly accurate measurement of the revolution of the rotary member 30 to be possible.

Also, since the end face of the inner race 2 is held in abutment with the step 30c of the rotary member 30, the code wheel 6 on the rotary member 30 can be positioned properly in the axial direction with the annular end face of the inner race 2 taken as a reference in positioning. For this reason, mounting of the inner race 2 relative to the rotary member 30 can easily be accomplished.

Although in describing any one of the foregoing embodiments of the present invention the rotation sensor unit 11 has been described as an optical rotation sensor unit, the rotation sensor unit 11 may be a magnetic rotation sensor unit. Where the magnetic rotation sensor unit is employed, the code signal inducing element 7 of the code wheel 6 has to be in the form of a multipolar magnet having a plurality of opposite magnetic poles N and S alternating with each other in a direction circumferentially thereof and, on the other hand, the sensor 10 has to be a Hall element, a magnetoresistive element or a coil having a yoke.

Also, although in describing any one of the foregoing embodiments of the present invention, the inner race 2 has been described as a rotating race, the outer race 3 may serve as a rotating race. In addition, the bearing 1 may not be always limited to a radial type, but may be a thrust type. Yet, the bearing 1 may not be always limited to a rolling bearing, but may be a non-contact bearing such as a plain bearing, a hydrostatic bearing or a hydrodynamic bearing.

The combined sensor and bearing assembly of the present invention can be effectively used in business machines such as a copying machine or a printer, and various industrial machines and equipments.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

1. A combined sensor and bearing assembly, which comprises:
a bearing including a rotating race and a non-rotating race;
a rotation sensor unit including a code wheel, provided on a rotary member rotatable together with the rotating race, and a sensor mounted on the non-rotating race.

2. The combined sensor and bearing assembly as claimed in claim 1, wherein the code wheel is a member separate from the rotary member and is fixed on the rotary member.

3. The combined sensor and bearing assembly as claimed in claim 2, wherein the bearing is a radial type rolling bearing and wherein the rotating race is an inner race and the rotary member is a rotary shaft engaged in the inner race.

4. The combined sensor and bearing assembly as claimed in claim 2, wherein the bearing assembly is a radial type rolling bearing and wherein the code wheel is fixed on the rotary member with an annular end face of the rotating race taken as a reference in positioning with respect to an axial direction of the bearing.

5. The combined sensor and bearing assembly as claimed in claim 1, wherein the code wheel includes a code signal inducing element held in face-to-face relation with the sensor in an axial direction of the bearing.

6. The combined sensor and bearing assembly as claimed in claim 1, wherein the code wheel includes a code signal inducing element held in face-to-face relation with the sensor in a radial direction of the bearing.

7. The combined sensor and bearing assembly as claimed in claim 1, wherein the code wheel is formed on the rotary member.

8. The combined sensor and bearing assembly as claimed in claim 7, wherein the bearing assembly is a radial type rolling bearing and the rotating race is an inner race and the rotary member is a rotary shaft having a large diameter shaft portion and a small diameter shaft portion with an annular step defined between the large and small diameter shaft portions and wherein the code wheel is formed on the large diameter shaft portion and the annular step is held in abutment with an annular end face of the rotating race.

9. The combined sensor and bearing assembly as claimed in claim 7, wherein the code wheel includes a code signal inducing element which is printed on the rotary member.

10. The combined sensor and bearing assembly as claimed in claim 1, wherein the rotation sensor unit is an optical rotation sensor unit.

11. The combined sensor and bearing assembly as claimed in claim 1, wherein the sensor is mounted on the non-rotating race through a ring-shaped sensor housing engageable with the non-rotating race and wherein the housing concurrently serves as a sealing element for sealing an annular bearing space defined between the rotating and non-rotating races.
